(19) United States
(12) Patent Application Publication
(10) Pub. No.: US 2021/0089306 A1
(43) Pub. Date: Mar. 25, 2021

(54) INSTRUCTION PROCESSING METHOD AND APPARATUS

(71) Applicant: ALIBABA GROUP HOLDING LIMITED, George Town (KY)

(72) Inventors: Chang LIU, Shanghai (CN); Tao JIANG, Hangzhou (CN)

(21) Appl. No.: 17/029,595

(22) Filed: Sep. 23, 2020

(30) Foreign Application Priority Data
Sep. 23, 2019 (CN) 201910900984.1

(51) Int. Cl. G06F 9/30; G06F 9/32; G06F 9/38

(52) U.S. Cl. CPC G06F 9/30054; G06F 9/3804; G06F 9/325; G06F 9/30058

(57) ABSTRACT

Embodiments of the present disclosure provide an instruction processing apparatus, comprising a count buffer; an instruction fetching circuitry configured to store address-related information of a jump instruction into the count buffer and to determine an information identifier corresponding to the address-related information, wherein the address-related information comprises address information of the jump instruction in a storage device; and an instruction executing circuitry configured to acquire the address-related information of the jump instruction from the count buffer according to the information identifier and execute the jump instruction according to the address-related information.

### CROSS REFERENCE TO RELATED APPLICATION

This disclosure claims benefits of priority to Chinese application number 201910900984.1, filed Sep. 23, 2019, which is incorporated herein by reference in its entirety.

### TECHNICAL FIELD

The present disclosure relates to the technical field of processors, and more particularly, to instruction processing methods and apparatuses for storing and transmitting address information of instructions.

### BACKGROUND

A modern processor generally uses a pipeline technology to improve a computing speed of the processor. The pipeline includes a plurality of processing units or circuitries with different functionalities (e.g., an instruction fetching circuitry, an instruction decoding circuitry, an instruction executing circuitry, or an instruction retiring circuitry). A processing procedure of an instruction can include a plurality of steps, each of which is executed by a corresponding processing circuitry. When a certain step of a certain instruction is completed by a certain processing circuitry, the instruction proceeds to a next processing circuitry in the pipeline for processing of a next step, and the processing circuitry continues to process a next instruction. When an instruction is processed by different parts of the pipeline, address-related information of the instruction is transmitted from one circuitry to another.

### SUMMARY

Embodiments of the present disclosure provide an instruction processing apparatus, comprising: a count buffer; an instruction fetching circuitry configured to store address-related information of a jump instruction into the count buffer and to determine an information identifier corresponding to the address-related information, wherein the address-related information comprises address information of the jump instruction in a storage device; and an instruction executing circuitry configured to acquire the address-related information of the jump instruction from the count buffer according to the information identifier and execute the jump instruction according to the address-related information.

Embodiments of the present disclosure further provide an instruction processing method, comprising: storing, by an instruction fetching circuitry, address-related information of a jump instruction into a count buffer; determining an information identifier corresponding to the address-related information, wherein the address-related information comprises address information of the jump instruction in a storage device; acquiring, by an instruction executing circuitry, the address-related information of the jump instruction from the count buffer according to the information identifier; and executing, by the instruction executing circuitry, the jump instruction according to the address-related information.

Embodiments of the present disclosure further provide a system on chip, comprising: an instruction processing apparatus, comprising: a count buffer; an instruction fetching circuitry configured to store address-related information of a jump instruction into the count buffer and to determine an information identifier corresponding to the address-related information, wherein the address-related information comprises address information of the jump instruction in a storage device; and an instruction executing circuitry configured to acquire the address-related information of the jump instruction from the count buffer according to the information identifier and execute the jump instruction according to the address-related information.

Embodiments of the present disclosure further provide an intelligent device, comprising a system on chip, comprising: an instruction processing apparatus, comprising: a count buffer; an instruction fetching circuitry configured to store address-related information of a jump instruction into the count buffer and to determine an information identifier corresponding to the address-related information, wherein the address-related information comprises address information of the jump instruction in a storage device; and an instruction executing circuitry configured to acquire the address-related information of the jump instruction from the count buffer according to the information identifier and execute the jump instruction according to the address-related information.

### BRIEF DESCRIPTION OF THE DRAWINGS

FIG. 1 is a schematic of an example instruction processing apparatus, according to some embodiments of the present disclosure.

FIG. 2 is a schematic of an example instruction set including sequential instructions and jump instructions, according to some embodiments of the present disclosure.

FIG. 3 is a chart of an example execution of an instruction set including a jump instruction, according to some embodiments of the present disclosure.

FIG. 4 is a flowchart of an example instruction processing method, according to some embodiments of the present disclosure.

FIG. 5 is a schematic of an example processor, according to some embodiments of the present disclosure.

FIG. 6 is a schematic of an example system on chip, according to some embodiments of the present disclosure.

### DETAILED DESCRIPTION

To make the objectives, technical solutions and advantages of the embodiments of the present disclosure clearer, the technical solutions in the embodiments of the present disclosure are described below with reference to the accompanying drawings in the embodiments of the present disclosure. The described embodiments are merely some rather than all of the embodiments of the present disclosure. Based on the embodiments in the present disclosure, all other embodiments obtained by those with ordinary skill in the art without creative efforts should fall within the protective scope of the present disclosure.

A Program Counter (“PC”) can store address information of instructions in a memory. A processor can read an instruction from the memory according to the address information stored in the PC. After the processor acquires the instruction according to the address information in the PC, the address information of the instruction can be stored and transmitted together with the instruction in any of the processing circuitries of the pipeline until the instruction is retired. Transmission of address information of an instruction in a pipeline and storage of the address information of the instruction in each processing circuitry of the pipeline can occupy a large amount of hardware resources, increasing the hardware cost of a processor.

Embodiments of the present disclosure provide novel processor designs for storing address information. In some embodiments, the processor can use a count buffer to store address-related information of jump instructions collectively, thus avoiding storing address information of the instructions in each processing circuitry on the pipeline and avoiding transmitting the address information of the instructions between the processing circuitries, thereby saving the hardware cost of the processing circuitries. In addition, in some embodiments, the count buffer of the present disclosure stores only address-related information of jump instructions, but does not store address-related information of sequential instructions. Generally, only a small number of instructions in the pipeline are jump instructions. As a result, the total number of entries in the count buffer is generally less than the total number of instructions on the pipeline, and the quantity of resources occupied by the count buffer can be less than the sum of address information of the instructions transmitted in the pipeline, thereby reducing the hardware cost of the entire instruction processing apparatus.

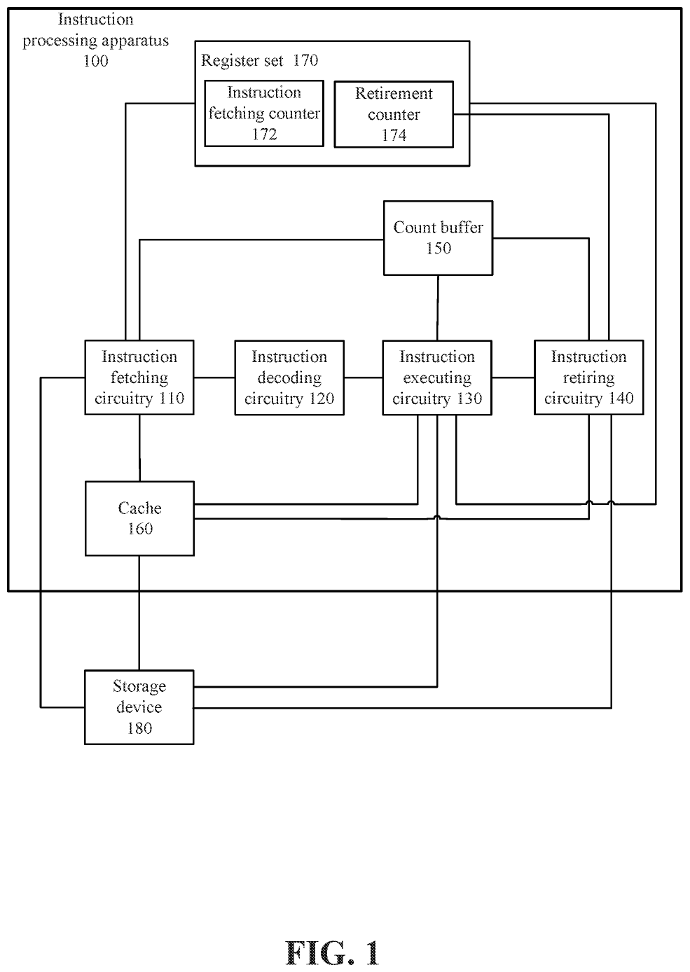

FIG. 1 is a schematic of an example instruction processing apparatus, according to some embodiments of the present disclosure. In some embodiments, instruction processing apparatus 100 may be a processor core in a single-core processor, a multi-core processor, or a processing element in an electronic system. It is appreciated that instruction processing apparatus 100 is not limited to being a processor core in a single-core processor, a multi-core processor, or a processing element in an electronic system. It is appreciated that the division of various components in FIG. 1 is functional, and they can be rearranged and combined for physical implementations without departing from the protection scope of the present disclosure.

In some embodiments, as shown in FIG. 1, instruction processing circuitry 100 can includes instruction fetching circuitry 110, instruction decoding circuitry 120, instruction executing circuitry 130, or instruction retiring circuitry 140. In some embodiments, any of instruction fetching circuitry 110, instruction decoding circuitry 120, instruction executing circuitry 130, and instruction retiring circuitry 140 can be communicative coupled with each other. These four processing circuitries can be parts of a processor pipeline, and they are respectively configured to fetch instructions, decode instructions, execute instructions, and write back results of the executed instructions.

In some embodiments, instruction processing apparatus 100 further comprises register set 170. Register set 170 can include a plurality of registers. In some embodiments, the plurality of registers are high-speed storage components with a limited storage capacity. The plurality of registers can be configured to temporarily store information such as instructions, data, or addresses. In some embodiments, register set 170 includes a variety of registers, such as a General Purpose Register (“GPS”), a Special Function Register (“SFR”), a control register, etc. In some embodiments, register set 170 can include a register storing PC. In some embodiments, the register storing PC may also be referred to as an instruction pointer register, which is an SFR configured to store address information of a next instruction to be executed.

In some embodiments, as shown in FIG. 1, the register storing PC in register set 170 can include instruction fetching counter 172 or retirement counter 174. Instruction fetching counter 172 can store address information of a next instruction to be read, and retirement counter 174 can store address information of a next instruction to be retired. In some embodiments, instruction fetching counter 172 and retirement counter 174 may be circuitries inside some of the processing circuitries in the processor pipeline. For example, instruction fetching counter 172 may be circuitry inside instruction fetching circuitry 110, and retirement counter 174 may be circuitry inside instruction retiring circuitry 140.

In some embodiments, storage device 180 can be communicatively coupled with instruction processing apparatus 100 and can be configured to store instructions and data. Storage device 180 may be, for example, a Read-Only Memory (“ROM”), a Random Access Memory (“RAM”), etc.

In some embodiments, instruction fetching circuitry 110 can acquire an instruction to be processed from cache 160, storage device 180, or other sources based on the address information stored in instruction fetching counter 172. Instruction fetching circuitry 110 can also update the value of instruction fetching counter 172 to the address of the next instruction to be executed.

In some embodiments, the instructions fetched by instruction fetching circuitry 110 may be a sequential instruction or a jump instruction. The sequential instruction is an instruction sequentially executed. For example, after execution of one instruction is completed, if a next instruction to be executed is an instruction next to the instruction in storage device 180, the instruction is a sequential instruction. The jump instruction is an instruction executed in a jump manner. For example, after execution of one instruction is completed, if a next instruction to be executed is not an instruction next to the instruction in storage device 180 but an instruction in another position of storage device 180, the instruction is a jump instruction.

In some embodiments, the jump instruction can be a conditional jump instruction or an unconditional jump instruction. The conditional jump instruction can also be referred to as a branch instruction, in which a condition is included. Depending on the condition, a program can execute different branches. In other words, depending on a result of the condition, the address of a next instruction to be executed can be different from a sequential execution. In some embodiments, the unconditional jump instruction does not include a condition. As a result, after the unconditional jump instruction is executed, a specific instruction may be unconditionally executed.

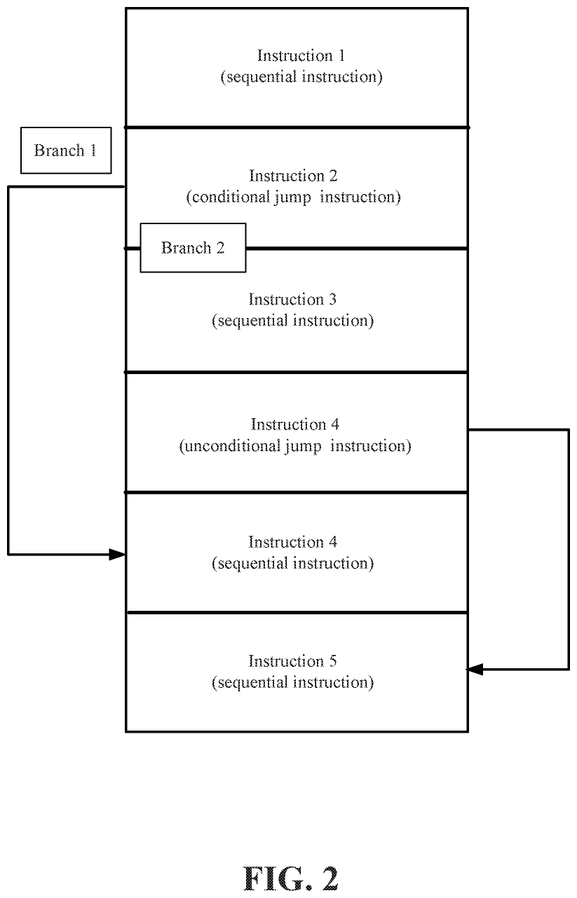

FIG. 2 is a schematic of an example instruction set including sequential instructions and jump instructions, according to some embodiments of the present disclosure. As shown in FIG. 2, six instructions from instruction 1 to instruction 6 can be consecutively stored in a certain area of storage device 180. Instructions 1, 3, 5, and 6 are sequential instructions. For example, after any of these instructions is executed, a next instruction following the executed instruction can be sequentially executed. Instruction 2 is a conditional jump instruction. For example, when a condition is met, branch 1 can be executed, and instruction 2 can jump to instruction 5. When the condition is not met, branch 2 is executed and instruction 3 can be sequentially executed. Instruction 4 is an unconditional jump instruction. For example, after instruction 4 is executed, the instruction flow jumps to instruction 6 and instruction 6 is executed.

In some embodiments, instruction decoding circuitry 120 receives instructions transmitted from instruction fetching circuitry 110 and decodes these instructions to generate low-level micro-operations, microcode entry points, micro-instructions, or other low-level instructions or control signals. The low-level instructions or control signals may implement operations of high-level instructions through low-level (e.g., circuit-level or hardware-level) operations. In some embodiments, instruction decoding circuitry 120 may be implemented using different mechanisms. For example, suitable mechanisms can include microcode, lookup tables, hardware, or programmable logic arrays (“PLAs”). It is appreciated that the present disclosure is not limited to various mechanisms for implementing instruction decoding circuitry 120, and any mechanism that can implement instruction decoding circuitry 120 falls within the protection scope of the present disclosure.

In some embodiments, instruction decoding circuitry 120 can send the decoded instructions to instruction executing circuitry 130, and instruction executing circuitry 130 can execute the instructions. In some embodiments, instruction executing circuitry 130 can include a circuit operable to execute instructions. In some embodiments, when executing these instructions, instruction executing circuitry 130 can receive data input from register set 170, cache 160, or storage device 180, and generate data to be outputted to register set 170, cache 160, or storage device 180.

In some embodiments, instruction executing circuitry 130 can send execution results from executing the instructions to instruction retiring circuitry 140. In some embodiments, in an instruction retirement stage, instruction retiring circuitry 140 can write the execution results of the instructions to corresponding storage components (e.g., a general-purpose register (“GPR”), a control register, storage device 180, etc.). In some embodiments, instruction executing circuitry 130 can write the execution results of the instructions to corresponding storage components. In some embodiments, instruction retiring circuitry can update the value of retirement counter 174 with the address of a next instruction to be executed, thereby updating the state of instruction processing apparatus 100.

In some embodiments, to facilitate retirement of an instruction by instruction retiring circuitry 140, instruction retiring circuitry 140 can obtain address information of an instruction currently being retired. In some embodiments, after instruction fetching circuitry 110 acquires an instruction according to address information in instruction fetching counter 172, the address information of the instruction can be stored temporarily and transmitted along with the instruction in each processing circuitry of the pipeline, and eventually the address information of the instruction can reach instruction retiring circuitry 140. In some embodiments, processing apparatus 100 executes instructions out of order. The address information of the instruction can be stored and transmitted in instruction fetching circuitry 110, instruction decoding circuitry 120, and a Re-Order Buffer (“ROB”). Transmission of address information of any instruction in a pipeline and storage of the address information of the instruction in each processing circuitry of the pipeline can occupy a large amount of hardware resources, increasing the hardware cost of a processor. To solve this issue, instruction processing apparatus 100 can include count buffer 150. In some embodiments, count buffer 150 can be communicatively coupled to instruction fetching circuitry 110, instruction executing circuitry 130, instruction retiring circuitry 140, or other processing units or circuitries on the pipeline. In some embodiments, count buffer 150 can collectively store address-related information of jump instructions to avoid storing address information of the instructions in each processing circuitry in the pipeline and avoid transmitting the address information of the instructions between the processing circuitries, thus saving the hardware cost of the processing circuitries.

In some embodiments, when an instruction currently read by instruction fetching circuitry 110 is a jump instruction, instruction fetching circuitry 110 can store address-related information of the jump instruction into count buffer 150 and determine an information identifier of the address-related information. In some embodiments, the address-related information can include address information of the jump instruction in storage device 180.

In some embodiments, instruction fetching circuitry 110 can transmit, through instruction decoding circuitry 120, the information identifier corresponding to the address-related information to subsequent processing units or circuitries such as instruction executing circuitry 130 or instruction retiring circuitry 140. The subsequent processing units or circuitries such as instruction executing circuitry 130 or instruction retiring circuitry 140 can acquire the address-related information of the jump instruction from count buffer 150 according to the information identifier. In addition, the subsequent processing units or circuitries can execute or retire the jump instruction according to the address-related information. In some embodiments, when a jump instruction is being processed in a pipeline, instead of the address-related information of the jump instruction, the information identifier can be transmitted between processing units and circuitries in the pipeline. When a certain processing unit or circuitry processes an instruction, if address-related information of the instruction needs to be used, the processing unit or circuitry may acquire the address-related information from count buffer 150 according to an information identifier, thus avoiding transmission and storage of address information of the instruction between various processing units and circuitries and saving the hardware cost of the processing units or circuitries.

In some embodiments, count buffer 150 can collectively store address-related information of jump instructions, and only information identifiers corresponding to the stored address-related information are transmitted in the pipeline. Related processing circuitries (e.g., instruction executing circuitry 130 or instruction retiring circuitry 140) in the pipeline may acquire the address-related information of the jump instructions from count buffer 150 according to the information identifiers. In some embodiments, for sequential instructions, since a next instruction to be executed is an instruction following a sequential instruction, address information of the next instruction can be deduced according to the length of the sequential instruction, and address information of the sequential instruction may not need to be additionally stored and transmitted. As a result, count buffer 150 does not need to store address-related information of the sequential instructions, and the processing units or circuitries in the pipeline do not need to store and transmit the address-related information of the sequential instructions. In some embodiments, only a small number of instructions in the pipeline are jump instructions. As a result, the total number of entries buffered in count buffer 150 is generally less than the total number of instructions in the pipeline, and the amount of hardware resources occupied by count buffer 150 is less than the hardware resources that would otherwise be used to store address information of the instructions transmitted in the pipeline. Therefore, the use of count buffer 150 can reduce the hardware cost of the instruction processing apparatus.

In some embodiments, instruction processing apparatus 100 comprises a plurality of count buffers 150. It is appreciated that the number of count buffers 150 included in instruction processing apparatus 100 is not limited in the present disclosure. It is appreciated that providing a plurality of count buffers 150 in instruction processing apparatus 100 can achieve technical effects such as increasing a storage capacity and improving information fault tolerance. The actual number of counter buffers 150 to be implemented or used in instruction processing apparatus 100 can depend on the actual design or purpose of instruction processing apparatus 100.

In some embodiments, when instruction processing apparatus 100 is provided with a plurality of count buffers 150, the plurality of count buffers 150 may store redundant address-related information. Redundant address-related information can be stored to improve information fault tolerance. For example, if certain count buffer 150 fails, the redundant information stored in other count buffers 150 may also guarantee the normal operation of instruction processing. In some embodiments, the plurality of count buffers 150 may store different address-related information, thus expanding the storage space and enabling the count buffers to store address-related information of more jump instructions. In some embodiments, the plurality of count buffers 150 may be divided into a plurality of groups. Different groups of count buffers 150 can store different address-related information, and count buffers 150 in the same group may store the same address-related information, so that the capacity can be expanded while the information fault tolerance is improved. In some embodiments, different groups of count buffers 150 can store different types of address-related information.

It is appreciated that the division of the components in FIG. 1 is functional, and the components shown in FIG. 1 can be rearranged and combined without departing from the protection scope of the present disclosure. For example, although count buffer 150 is illustrated as a separate component in instruction processing apparatus 100 of FIG. 1, it is appreciated that count buffer 150 may also be integrated within some components (e.g., within instruction fetching counter 172). In some embodiments, instruction retiring circuitry 140 shown in FIG. 1 may also be a circuit integrated within instruction executing circuitry 130. Cache 160 may further include one or more intermediate level caches, such as level 2 (“L2”), level 3 (“L3”), level 4 (“L4”), other levels of caches including last level cache (“LLC”), etc.

In some embodiments, instruction fetching circuitry 110 can read one or more instructions from cache 160, storage device 180, or other sources according to address information in instruction fetching counter 172. Instruction fetching circuitry 110 can pre-decode an instruction to determine an opcode of the instruction, and determine an operation type of the instruction according to the opcode (e.g., determining whether the instruction is a jump instruction).

An opcode can be a short code for indicating an operation type of an instruction. Opcodes can include, for example, move (mov), add (add), subtract (sub), halt (hlt), conditional branch (jz), etc. In some embodiments, each opcode can correspond to an operation type. Therefore, after an opcode of an instruction is identified, it can be determined if the instruction corresponds to a jump operation. In some embodiments, the specific type of the jump instruction can be determined. For example, it can be determined if the instruction is a conditional jump instruction or an unconditional jump instruction. Common opcodes of jump instructions include j, jz, jnz, je, jmp, etc.

In some embodiments, when the instruction read by instruction fetching circuitry 110 is determined to be a jump instruction, instruction fetching circuitry 110 can store address-related information of the jump instruction into count buffer 150, and determine an information identifier of the address-related information. In some embodiments, the address-related information can include address information of the jump instruction in storage device 180.

In some embodiments, the information identifier of the address-related information of the jump instruction may be determined according to a storage position of the address information in count buffer 150. For example, count buffer 150 can include N entries, each of which can be used to store address-related information of a jump instruction. As a result, count buffer 150 can store address-related information of N jump instructions. If address-related information of a certain jump instruction is stored into the fifth entry of count buffer 150, an information identifier of the address-related information of the jump instruction may be correspondingly set to 5. It is appreciated that other methods may also be used to determine an information identifier of address-related information in addition to the method described above. The method for determining an information identifier is not limited in the present disclosure, For example, in some embodiments, the information identifier can uniquely correspond to address-related information of a jump instruction.

In some embodiments, address-related information of a jump instruction can include address information of the jump instruction in a storage device. In some embodiments, in addition to including address information of a jump instruction, the address-related information may further include information such as a type of the jump instruction (e.g., a conditional jump instruction, an unconditional jump instruction, or a type divided according to other classification standards) or a prediction result of a branch instruction. It is appreciated that specific information items included in the address-related information may vary according to a different type of the jump instruction.

In some embodiments, when instruction fetching circuitry 110 reads a conditional jump instruction, instruction fetching circuitry 110 may predict whether the conditional jump instruction leads to a jump (e.g., perform branch prediction), and a prediction result and address information of the conditional jump instruction can be stored as address-related information of the conditional jump instruction into count buffer 150. In some embodiments, the type of the jump instruction (e.g., conditional jump instruction) may be stored in count buffer 150. For example, the address-related information of the conditional jump instruction may further include a type identifier of the jump instruction.

In some embodiments, when instruction fetching circuitry 110 reads the conditional jump instruction, instruction fetching circuitry 110 can determines according to the prediction result, address information of a next instruction to be read or executed. Instruction fetching circuitry can update the address information of the next instruction to be read or executed in instruction fetching counter 172. In some embodiments, instruction fetching circuitry 110 may use, a static branch prediction method to always predict a first branch or a second branch of a conditional jump instruction. In some embodiments, instruction fetching circuitry 110 may use a dynamic branch prediction method to predict, according to historical branch hits, whether a current conditional jump instruction may lead to a jump. It is appreciated that the specific branch prediction policy used in instruction fetching circuitry 110 is not limited in the present disclosure, and any branch prediction policy falls within the protection scope of the present disclosure.

In some embodiments, instruction fetching circuitry 110 reads an unconditional jump instruction, which specifies a jump target address (e.g., an address of a next instruction to be executed). Instruction fetching circuitry 110 may pre-decode the jump target address and determine the jump target address of the unconditional jump instruction. Instruction fetching circuitry 110 can then update the jump target address as address information of a next instruction to be read to instruction fetching counter 172. In some embodiments, address-related information of the unconditional jump instruction may include only address information of the unconditional jump instruction. In some embodiments, address-related information of the unconditional jump instruction may further include information such as a type identifier or a jump target address of the unconditional jump instruction.

In some embodiments, after the address-related information of the jump instruction is stored into count buffer 150 and an information identifier corresponding to the address-related information is determined, instruction fetching circuitry 110 can send the jump instruction and the information identifier to instruction decoding circuitry 120. Instruction decoding circuitry 120 can decode the instruction to generate low-level micro-operations, microcode entry points, micro-instructions, or other low-level instructions or control signals. For example, instruction decoding can 120 can obtain, by decoding, information required to execute the instruction, which can include information such as an operation type of the instruction (e.g., addition, subtraction, multiplication, division, and other operations), an operand address (e.g., a source operand address or a target register address), or an instruction length (e.g., 32 bits). Then, instruction decoding circuitry 120 can send the information of the decoded instruction and the information identifier corresponding to the instruction to instruction executing circuitry 130.

In some embodiments, instruction executing circuitry 130 can execute a jump instruction according to instruction information sent from instruction decoding circuitry 120. After execution, instruction executing circuitry 130 can send an execution result of the jump instruction and the information identifier to instruction retiring circuitry 140. Instruction retiring circuitry 140 can receive the information identifier sent from instruction executing circuitry 130, and acquire the address-related information of the jump instruction from count buffer 150 according to the information identifier, so as to retire the jump instruction. It is appreciated that processing steps performed by instruction executing circuitry 130 and instruction retiring circuitry 140 can vary according to a different type of the jump instruction.

In some embodiments, when the jump instruction is a conditional jump instruction, instruction executing circuitry 130 can execute the conditional jump instruction and determine a jump condition according to an execution result indicating whether a jump occurs. In some embodiments, instruction executing circuitry 130 can acquire a prediction result of the jump instruction from count buffer 150 according to the received information identifier. Instruction executing circuitry 130 can determine whether the acquired prediction result is consistent with the execution result of the conditional jump instruction. Instruction executing circuitry 130 can send a determination result and the information identifier to instruction retiring circuitry 140. Instruction retiring circuitry 140 can determine, according to the determination result and the information identifier, address information of a next instruction to be retired. Instruction retiring circuitry 140 can update retirement counter 174 with the address information of the next instruction to be retired.

In some embodiments, instruction retiring circuitry 140 can receive the determination result and the information identifier sent from instruction executing circuitry 130, acquire address-related information of the conditional jump instruction from count buffer 150 according to the information identifier, and delete the address-related information of the conditional jump instruction stored in count buffer 150. In some embodiments, instruction retiring circuitry 140 can determine, according to the determination result sent from instruction executing circuitry 130, the address information, and the prediction result of the conditional jump instruction acquired from count buffer 150, the address information of the next instruction to be retired. Instruction retiring circuitry 140 can update retirement counter 174 with the address information of the next instruction to be retired.

For example, when the determination result sent from instruction executing circuitry 130 indicates that the prediction result and the execution result of the conditional jump instruction are consistent, the prediction can be indicated as correct. Instruction retiring circuitry 140 may determine, according to the address information, the prediction result of the conditional jump instruction and the determination result, address information of a next instruction to be executed, which can also be the next instruction to be retired. Instruction retiring circuitry 140 can update retirement counter 174 with the address information of the next instruction to be executed. In some embodiments, since the prediction is correct, address information of a next instruction currently stored in instruction fetching counter 172 can also be indicated as correct, and instruction fetching counter 172 does not need to be updated or modified.

In some embodiments, when the determination result sent from instruction executing circuitry 130 indicates that the prediction result and the execution result of the conditional jump instruction are inconsistent, the prediction can be indicated as incorrect. Therefore, instruction retiring circuitry 140 can determine, according to the address information, the execution result of the conditional jump instruction, and the determination result, address information of a next instruction to be executed, and update retirement counter 174 with the address information of the next instruction to be executed.

In some embodiments, address information of a next instruction currently stored in instruction fetching counter 172 can be determined according to the prediction result. For example, since the prediction is incorrect, the address information stored in instruction fetching counter 172 may also be incorrect and needs to be updated. Therefore, when the determination result indicates that the prediction result and the execution result of the conditional jump instruction are inconsistent, instruction retiring circuitry 140 can determine, according to the received determination result and the address information of the conditional jump instruction, address information of a next instruction to be read, and updates retirement counter 172 with the address information of the next instruction to be executed.

In some embodiments, when the jump instruction is an unconditional jump instruction, instruction executing circuitry 130 can execute the unconditional jump instruction to obtain an execution result indicating that a jump is determined. In some embodiments, instruction executing circuitry 130 may acquire the address-related information from count buffer 150 according to the information identifier, and further determine an execution result of the jump. Then, instruction executing circuitry 130 can send the execution result indicating that a jump is determined and the information identifier to instruction retiring circuitry 140. Instruction retiring circuitry 140 can determine address information of a next instruction to be executed, and update retirement counter 174 with the address information of the next instruction to be executed.

In some embodiments, instruction retiring circuitry 140 can receive the execution result indicating that a jump is determined and the information identifier from instruction executing circuitry 130 and acquire address-related information of the unconditional jump instruction from count buffer 150 according to the information identifier. Instruction retiring circuitry can then delete the address-related information of the unconditional jump instruction stored in count buffer 150. Instruction retiring circuitry 140 can determine a jump address of the unconditional jump instruction according to address information of the unconditional jump instruction and the execution result indicating that a jump is determined. The jump target address is an address of the next instruction to be executed. In some embodiments, the next instruction to be executed can also be a next instruction to be retired. Instruction retiring circuitry 140 can update retirement counter 174 with the jump target address as address information of the next instruction to be retired.

In some embodiments, count buffer 150 can include a plurality of entries, each of which can correspond to address-related information of one jump instruction. Each entry of count buffer 150 may be identified and distinguished by an information identifier.

In some embodiments, count buffer 150 can be implemented using a queue data structure, and entries in count buffer 150 can follow a First In First Out (“FIFO”) storage format. For example, entries can be popped up or deleted in the same order as they are created or stored.

In some embodiments, when instruction fetching circuitry 110 pre-decodes a jump instruction, instruction fetching circuitry 110 may store address-related information of the jump instruction into an entry in count buffer 150, and determine an information identifier of the entry. Then, instruction fetching circuitry 110 can sequentially transmit the information identifier of the entry along with the jump instruction to other parts of the pipeline (e.g., instruction decoding circuitry 120, instruction executing circuitry 130, instruction retiring circuitry 140, etc.). The entries in count buffer 150 can be created according to an execution order of the instructions.

In some embodiments, count buffer 150 can include at least two pointers, such as, a create pointer and a retire pointer. The create pointer can point to a null entry to be created in count buffer 150, and an identifier of the entry to which the create pointer points is an information identifier of a next jump instruction. The retire pointer can point to an older entry in count buffer 150. In some embodiments, the older entry can be the oldest entry in count buffer 150. In some embodiments, the oldest entry in count buffer 150 can be an entry corresponding to a next jump instruction to be retired. Count buffer 150 can determine whether count buffer 150 is empty or full through the create pointer and the retire pointer. When counter buffer 150 is full, instruction fetching circuitry 110 may not be able to create a new jump instruction entry in counter buffer 150, As a result, instruction fetching circuitry 110 may suspend the execution and wait for an entry from count buffer 150 to free up.

In some embodiments, when instruction executing circuitry 130 executes a jump instruction out of order, address-related information of the jump instruction can be acquired from count buffer 150 according to an information identifier of the jump instruction. In some embodiments, after the execution of the jump instruction, instruction executing circuitry 130 may store a part of the execution result in a corresponding entry of count buffer 150. In the instruction retirement stage, instruction retiring circuitry 140 can acquire the address-related information including the part of the execution result count buffer 150 according to the information identifier, and update retirement counter 174 according to the acquired address-related information. After the jump instruction is retired, the entry corresponding to the instruction can be popped up or deleted from count buffer 150.

In some embodiments, since instructions are retired according to the execution order, the pop-up of the entries in count buffer 150 can also be performed according to the execution order of the instructions.

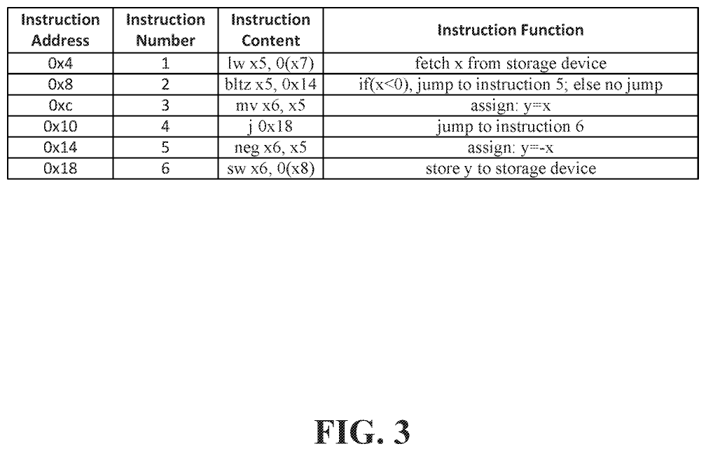

FIG. 3 is a chart of an example execution of an instruction set including a jump instruction, according to some embodiments of the present disclosure. It is appreciated that the instruction set shown in FIG. 3 can be executed by instruction processing apparatus 100 of FIG. 1. As shown in FIG. 3, the instruction set can be stored in storage addresses of 0x4 to 0x18 of a storage device (e.g., storage device 180 of FIG. 1). The instruction set includes six instructions, namely instruction 1 to instruction 6. It is appreciated that the function implemented by the instruction set is to determine an absolute value of variable x. In some embodiments, prior to execution of the instruction set in the table shown in FIG. 3, addresses stored in instruction fetching counter 172 and retirement counter 174 are both 0x4, indicating that a next instruction to be read and a next instruction to be retired are both instruction 1.

As shown in FIG. 3, instruction fetching circuitry 110 reads instruction 1 according to address 0x4 in instruction fetching counter 172. Instruction fetching circuitry 110 can pre-decode instruction 1, and determine that instruction 1 is a sequential instruction. In some embodiments, instruction fetching circuitry 110 can determine that instruction 1 is not a jump instruction. The next instruction to be read is instruction 2 following instruction 1, and the value of instruction fetching counter 172 can be updated to the address of instruction 2, namely 0x8. Instruction 1 is sent to instruction decoding circuitry 120.

Instruction decoding circuitry 120 decodes instruction 1 and determines instruction information such as an operation type of instruction 1 being a memory load operation lw (“load word”), an operand address being content stored in register x7 (corresponding to an indirect addressing manner), a target register being register x5, and an instruction length being 32 bits. Instruction decoding circuitry 120 can send the instruction information of instruction 1 to instruction executing circuitry 130.

Instruction executing circuitry 130 receives the instruction information of instruction 1 sent from instruction decoding circuitry 120. Instruction executing circuitry 130 can extract the value of variable x from the memory according to the operand address 0(x7). Instruction executing circuitry 130 can send the extracted value of x as an execution result of instruction 1 and information such as the target register x5 and the instruction length being 32 bits to instruction retiring circuitry 140.

Instruction retiring circuitry 140 writes the value of x into register x5. Instruction retiring circuitry 140 can update the value of retirement counter 174 to 0x8. In some embodiments, the instruction length of 32 bits can be added to the original value 0x4. Instruction retiring circuitry 140 can retire instruction 1.

Instruction fetching circuitry 110 reads instruction 2 according to the address 0x8 in instruction fetching counter 172. Instruction fetching circuitry 110 can pre-decode instruction 2, and determine instruction 2 as a branch instruction (e.g., a conditional jump instruction) based on an opcode bltz (“branch less than zero”) of instruction 2. Then, instruction fetching circuitry 110 can predict the branch instruction and create a prediction result (e.g., no jump). Instruction fetching circuitry 110 can store in count buffer 150 the prediction result, the address 0x8 of instruction 2, or other related information as address-related information of instruction 2. Instruction fetching circuitry 110 can determine, according to a storage position of the address-related information in count buffer 150, an information identifier corresponding to the address-related information. For example, if address-related information of instruction 2 is created and stored in entry 5 of count buffer 150, the information identifier of instruction 2 can be 5.

If “no jump” is predicted, a next instruction to be executed is instruction 3 located in 0xc, which is the next instruction in sequence. Therefore, instruction fetching circuitry 110 can update the value of instruction fetching counter 172 to xc. Then, instruction fetching circuitry 110 sends instruction 2 and the information identifier of instruction 2 to instruction decoding circuitry 120.

Instruction decoding circuitry 120 decodes instruction 2, determines instruction information such as an operation type of instruction 2 being bltz, an operand address being register x5, and an instruction length being 32 bits, and sends the instruction information and the information identifier of instruction 2 to instruction executing circuitry 130.

Instruction executing circuitry 130 acquires the prediction result “no jump” of instruction 2 from count buffer 150 according to the information identifier. Instruction executing circuitry 130 may execute instruction 2, acquire the value of x from register x5, and determine whether the value of x is smaller than 0. If the value of x is smaller than 0, instruction 2 leads to a jump. As a result, an execution result of instruction 2 is inconsistent with the prediction result of instruction fetching circuitry 110, and the prediction is determined to be incorrect. If the value of x is not smaller than 0, instruction 2 does not lead to a jump. As a result, the execution result of instruction 2 is consistent with the prediction result from instruction fetching circuitry 110, and the prediction is determined to be correct.

Instruction executing circuitry 130 sends a determination result of whether the prediction is correct and the information identifier of instruction 2 to instruction retiring circuitry 140.

In some embodiments, assuming that the prediction is correct, instruction executing circuitry 130 may send the result indicating that the prediction is correct and the information identifier of instruction 2 to instruction retiring circuitry 140. Instruction retiring circuitry 140 can acquire the address information 0x8 of instruction 2 and the prediction result “no jump” from count buffer 150 according to the information identifier of instruction 2. Instruction retiring circuitry can then pop up the entry corresponding to instruction 2 from count buffer 150. In other words, instruction retiring circuitry can delete the address-related information of instruction 2 buffered in count buffer 150. Instruction retiring circuitry 140 can determine, according to the address information 0x8 of instruction 2 and the correct prediction result of “no jump,” that the address of the next instruction to be executed is 0xc. Instruction retiring circuitry 140 can update the value of retirement counter 174 to 0xc. As a result, instruction 3 can be executed.

In some embodiments, assuming that the prediction is incorrect, instruction executing circuitry 130 may send the result indicating that the prediction is incorrect and the information identifier of instruction 2 to instruction retiring circuitry 140. Instruction retiring circuitry 140 acquires the address information 0x8 of instruction 2 and the prediction result “no jump” from count buffer 150 according to the information identifier of instruction 2. Instruction retiring circuitry 140 can then pop up the entry corresponding to instruction 2 from count buffer 150. In other words, instruction retiring circuitry can delete the address-related information of instruction 2 buffered in count buffer 150. Instruction retiring circuitry 140 determines, according to the address information 0x8 of instruction 2 and the incorrect prediction result “no jump,” that the address of the next instruction to be executed is 0x14. Instruction retiring circuitry 140 can then update the value of retirement counter 174 to 0x14. Moreover, because the current address in instruction fetching counter 172 is obtained by instruction fetching circuitry 110 according to the incorrect prediction result, address information currently stored in instruction fetching counter 172 can also be indicated as incorrect, and the address information needs to be modified. The instruction retiring circuitry 140 can update instruction fetching counter 172 with the correct address information 0x14 of the next instruction to be executed. As a result, instruction 5 can be executed.

For instruction 3, instruction fetching circuitry 110 can read instruction 3 according to the address 0xc in instruction fetching counter 172. Instruction fetching circuitry 110 can pre-decode instruction 3, and determine that instruction 3 is a sequential instruction, In some embodiments, instruction fetching circuitry 110 can determine that instruction 3 is not a jump instruction. The next instruction to be read is instruction 4 following instruction 3, and the value of instruction fetching counter 172 can be updated to the address of instruction 4, namely 0x10. Then, instruction 3 is sent to instruction decoding circuitry 120.

Instruction decoding circuitry 120 decodes instruction 3 and determines instruction information such as an operation type of instruction 3 being a data move operation my (“move”), a source address of the data move operation being register x5, a target address being register x6, and an instruction length being 32 bits. instruction decoding circuitry sends the instruction information to instruction executing circuitry 130.

Instruction executing circuitry 130 receives the instruction information of instruction 3 sent from instruction decoding circuitry 120 and extracts the value of x from the source address (register x5). Instruction executing circuitry 130 sends the extracted value of x as an execution result of instruction 3 and the information such as the target address being register x6 and the instruction length being 32 bits to instruction retiring circuitry 140.

Instruction retiring circuitry 140 can write the value of x into register x6 and update the value of retirement counter 174 to 0x10 of instruction 4. For example, the instruction length of 32 bits can be added to the original value 0xc.

Instruction fetching circuitry 110 reads instruction 4 according to the address 0x10 in instruction fetching counter 172. Instruction fetching circuitry 110 can pre-decode instruction 4 and determine that instruction 4 is an unconditional jump instruction based on an opcode j (“jump”) of instruction 4. Then, instruction fetching circuitry 110 can store in count buffer 150 the address 0x10 of instruction 4 and other related information as address-related information of instruction 4. Instruction fetching circuitry 110 can determine, according to a storage position of the address-related information in count buffer 150, an information identifier corresponding to the address-related information. For example, the address-related information of instruction 4 can be stored in entry 6 of count buffer 150. As a result, the information identifier of instruction 4 is 6.

Instruction 4 is an unconditional jump instruction. After instruction 4 is executed, instruction 4 can lead to an unconditional jump to the target address 0x18. As a result, instruction fetching circuitry 110 can update the value of instruction fetching counter 172 to 0x18.

Instruction fetching circuitry 110 sends instruction 4 and the information identifier of instruction 4 to instruction decoding circuitry 120. Instruction decoding circuitry 120 decodes instruction 4 and determines instruction information such as an operation type of instruction 4 being j and an instruction length being 32 bits. Instruction fetching circuitry 110 sends the instruction information and the information identifier of instruction 4 to instruction executing circuitry 130.

Instruction executing circuitry 130 acquires the address information 0x10 of instruction 4 from count buffer 150 according to the information identifier of instruction 4, determines an execution result of instruction 4 as “jump,” and sends the execution result “jump” and the information identifier of instruction 4 to instruction retiring circuitry 140.

Instruction retiring circuitry 140 acquires the address information 0x10 of instruction 4 from count buffer 150 according to the information identifier. Instruction retiring circuitry 140 can then pop up the entry corresponding to instruction 4 from count buffer 150. In other words, instruction retiring circuitry 140 can delete the address information of instruction 4 buffered in count buffer 150. The instruction retiring circuitry 140 determines that an address of a next instruction is 0x18 according to the execution result jump and the address information 0x10 of instruction 4, and updates the value of retirement counter 174 to x18.

For instruction 5, if it is obtained, during the execution of instruction 2, that the prediction of instruction fetching circuitry 110 is incorrect, instruction retiring circuitry 140 may update the values of instruction fetching counter 172 and retirement counter 174 to 0x14. Instruction fetching circuitry 110 reads instruction 5 according to the address 0x14 in instruction fetching counter 172. Instruction fetching circuitry 110 can pre-decode instruction 5, and determine that instruction 5 is a sequential instruction. As a result, the next instruction to be read is instruction 6 following instruction 5, and the value of instruction fetching counter 172 can be updated to the address of instruction 6, namely 0x18. Then, instruction 5 is sent to instruction decoding circuitry 120.

Instruction decoding circuitry 120 decodes instruction 5. Instruction decoding circuitry 120 can determine instruction information such as an operation type of instruction 5 being a data move negative operation neg (“negative”), a source address of the data move operation being register x5, a target address being register x6, and an instruction length being 32 bits. Instruction decoding circuitry 120 sends the instruction information to instruction executing circuitry 130.

Instruction executing circuitry 130 receives the instruction information sent from instruction decoding circuitry 120, extracts the value of x from the source address (e.g., register x5), then performs a neg operation on x. Instruction executing circuitry 130 sends an execution result (e.g., the value of −x) of instruction 5 and the information such as the target address being register x6 and the instruction length being 32 bits to instruction retiring circuitry 140.

Instruction retiring circuitry 140 can write the value of −x into register x6 and update the value of retirement counter 174 with the address 0x18 of instruction 6. For example, the instruction length of 32 bits can be added to the original value 0x14.

Instruction fetching circuitry 110 reads instruction 6 according to the address 0x18 in instruction fetching counter 172. Instruction fetching circuitry 110 can pre-decode instruction 6, and determine that instruction 6 is a sequential instruction. In some embodiments, instruction fetching circuitry 110 can determine that instruction 6 is not a jump instruction. In some embodiments, instruction fetching circuitry 110 can determine that instruction 6 is the last instruction in the instruction set. As a result, the value of instruction fetching counter 172 may no longer be updated. Then, instruction 6 is sent to instruction decoding circuitry 120.

Instruction decoding circuitry 120 decodes instruction 6, determines an operation type of instruction 6 as a memory write operation sw (“save word”), a source address of the write operation being register x6, a target memory address being content stored in register x8, and an instruction length being 32 bits. Instruction decoding circuitry 120 sends the instruction information to instruction executing circuitry 130.

Instruction executing circuitry 130 receives the instruction information sent from instruction decoding circuitry 120, extracts the value of y from the source address (e.g., register x6), and then sends an execution result (e.g., the extracted value of y) of the instruction and the information such as the target memory address 0(x8) and the instruction length being 32 bits to instruction retiring circuitry 140. Instruction retiring circuitry 140 writes a value of y in the address indicated by register x8.

It is appreciated that although the processing procedures of the instructions are described respectively, based on the pipeline technology, the processing procedures of the instructions may overlap in time. In other words, a plurality of instructions may be processed in a pipeline at a certain moment. For example, at a certain moment, the instruction fetching circuitry is reading instruction 2, while the instruction decoding circuitry is decoding instruction 1. Moreover, different circuitries described in the present disclosure and their functionalities can be re-arranged and combined. For example, instruction fetching circuitry 110 can include instruction decoding circuitry 120, and the functionalities of instruction decoding circuitry 120 can be conducted by instruction fetching circuitry 110.

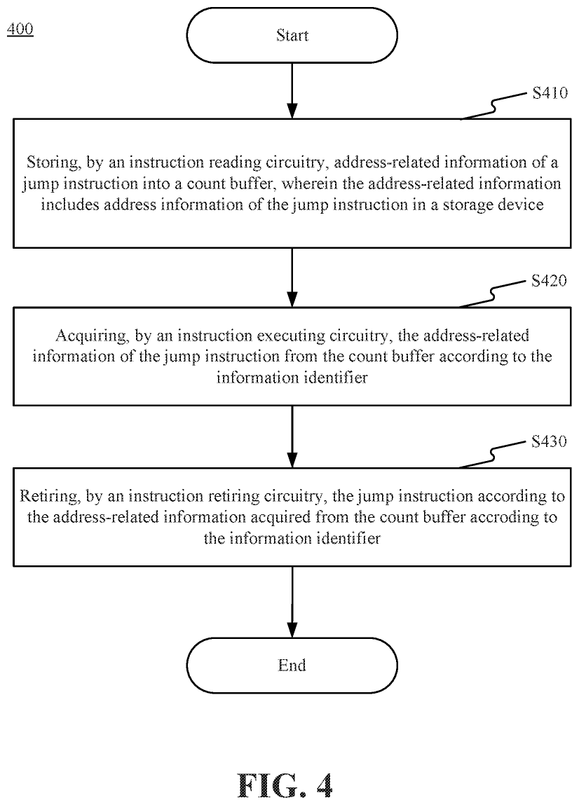

FIG. 4 is a flowchart of an example instruction scheduling method, according to some embodiments of the present disclosure. It is appreciated that instruction processing method 400 shown in FIG. 4 can be executed by instruction processing apparatus 100 shown in FIG. 1, and can be used to avoid storage and transmission of address information of an instruction on the pipeline.

In step S410, an instruction fetching circuitry (e.g., instruction fetching circuitry 110 of FIG. 1) can store address-related information of the jump instruction into a count buffer (e.g., count buffer 150 of FIG. 1). In some embodiments, instruction fetching circuitry can transmit an information identifier corresponding to the address-related information to an instruction executing circuitry (e.g., instruction executing circuitry 130 of FIG. 1). The address-related information includes address information of the jump instruction in a storage device.

In some embodiments, prior to step S410, the instruction fetching circuitry can determine, if the read instruction is a jump instruction. For example, instruction fetching circuitry can pre-decode the instruction to determine an opcode of the instruction, and determine, according to the opcode, whether the instruction is a jump instruction. Further, the jump instruction can be a conditional jump instruction or an unconditional jump instruction. As a result, the instruction fetching circuitry can determine, according to the opcode of the instruction, if the instruction is a conditional jump instruction or an unconditional jump instruction.

In some embodiments, in step S410, the address-related information of the jump instruction can include the address information of the jump instruction in the storage device. In some embodiments, the address-related information may include information such as a type of the jump instruction (e.g., a conditional jump instruction, an unconditional jump instruction, or a type divided according to other classification standards) or a prediction result of a branch instruction. It is appreciated that specific information items included in the address-related information may vary according to a different type of the jump instruction.

In some embodiments, when reading the conditional jump instruction, the instruction fetching circuitry can predict whether the conditional jump instruction leads to a jump, and stores a prediction result and address information of the conditional jump instruction as address-related information of the conditional jump instruction into the count buffer. In some embodiments, the instruction fetching circuitry can determine, according to the prediction result, address information of a next instruction to be read, and update an instruction fetching counter (e.g., instruction fetching counter 172 of FIG. 1) with address information of the next instruction to be read.

In some embodiments, when reading the unconditional jump instruction, the instruction fetching circuitry can determine a jump target address of the unconditional jump instruction, and update the instruction fetching counter with the jump target address as address information of a next instruction to be read.

In some embodiments, the information identifier of the address-related information of the jump instruction can be determined according to a storage position of the address-related information of the jump instruction in the count buffer. For example, the count buffer can include N entries, and each of the N entries can be used to store address-related information of one jump instruction. As a result, count buffer can store address-related information of N jump instructions. In some embodiments, if address-related information of a certain jump instruction is stored into the fifth entry of the count buffer, an information identifier of the address-related information of the jump instruction may be correspondingly set to 5.

In some embodiments, after the address-related information of the jump instruction is stored into the count buffer and an information identifier corresponding to the address-related information is determined, the instruction fetching circuitry can send the jump instruction and the information identifier to the instruction decoding circuitry. The instruction decoding circuitry can decode the jump instruction and send the decoding result together with the information identifier to the instruction executing circuitry.

In step S420, the instruction executing circuitry can acquire the address-related information of the jump instruction from the count buffer according to the information identifier. In some embodiments, the instruction executing circuitry 130 can execute the jump instruction according to the address-related information.

In some embodiments, method 400 further includes step that is performed after step S420. In step S430, an instruction retiring circuitry (e.g., instruction retiring circuitry 140 of FIG. 1) can receive the information identifier sent from the instruction executing circuitry, acquire the address-related information of the jump instruction from the count buffer according to the information identifier, and retire the jump instruction according to the address-related information. For example, the instruction retiring circuitry 140 can update address information in a retirement counter (e.g., retirement counter 174) according to the address-related information and write back a running result of the instruction to a register and the storage device.

It is appreciated that specific processes of executing the jump instruction in step S420 and retiring the jump instruction in step S430 can vary according to a different type of the jump instruction.

In some embodiments, the jump instruction is a conditional jump instruction. In step S420, the instruction executing circuitry can execute the conditional jump instruction and determine a jump condition according to an execution result of whether a jump occurs. Moreover, a prediction result of the conditional jump instruction can be obtained from the count buffer according to the information identifier. The instruction executing circuitry can determine whether the acquired prediction result is consistent with an actual execution result of the conditional jump instruction. In some embodiments, instruction executing circuitry 130 can send a determination result and the information identifier to the instruction retiring circuitry.

In step S430, the instruction retiring circuitry can receive the determination result and the information identifier sent from the instruction executing circuitry, acquire address-related information of the conditional jump instruction from the count buffer according to the information identifier, and delete the address-related information of the conditional jump instruction stored in the count buffer. Then, the instruction retiring circuitry can determine, according to the determination result sent from the instruction executing circuitry, the address information, and the prediction result of the conditional jump instruction acquired from the count buffer, the address information of the next instruction to be retired or the next instruction to be executed. The instruction retiring circuitry can update the retirement counter with the address information of the next instruction to be retired.

In some embodiments, when the determination result sent from the instruction executing circuitry indicates that the prediction result and the execution result of the conditional jump instruction are consistent, the prediction can be indicated as correct. The instruction retiring circuitry may determine, according to the address information, the prediction result and the execution result of the conditional jump instruction, address information of a next instruction to be executed or retired). The instruction retiring circuitry can update the retirement counter with address information of the next instruction to be executed. In some embodiments, since the prediction is correct, address information of a next instruction currently stored in the instruction fetching counter may also be correct and does not need to be updated or modified.

In some embodiments, when the determination result sent from the instruction executing circuitry indicates that the prediction result and the execution result of the conditional jump instruction are inconsistent, the prediction can be indicated as incorrect. The instruction retiring circuitry can determine, according to the address information and the execution result of the conditional jump instruction, address information of a next instruction to be executed. The instruction retiring circuitry can update the retirement counter with address information of the next instruction to be executed. In some embodiments, address information of a next instruction currently stored in the instruction fetching counter can be determined according to the prediction result. Since the prediction is incorrect, the address information stored in the instruction fetching counter may also be incorrect and needs to be modified. Therefore, in some embodiments, when the determination result indicates that the prediction result and the execution result of the conditional jump instruction are inconsistent, the instruction retiring circuitry can determine, according to the received determination result and the address information of the conditional jump instruction, address information of a next instruction to be read or executed. The instruction retiring circuitry can update the instruction fetching counter with the address information of the next instruction to be read.

In some embodiments, when the jump instruction is an unconditional jump instruction, in step S420, the instruction executing circuitry can execute the unconditional jump instruction to obtain an execution result indicating that a jump is determined. In some embodiments, the instruction executing circuitry 130 may acquire the address-related information from the count buffer according to the information identifier, and determine an execution result of the jump. Then, the instruction executing circuitry 130 can send the execution result indicating that a jump is determined and the information identifier to the instruction retiring circuitry 140, so that the instruction retiring circuitry 140 can perform step S430 to retire the jump instruction. The instruction retiring circuitry 140 can determine address information of a next instruction to be retired or executed and update the retirement counter with the address information of the next instruction to be retired to.

In some embodiments, in step S430, the instruction retiring circuitry can receive the execution result indicating that a jump is determined and the information identifier sent from the instruction executing circuitry, acquire address-related information of the unconditional jump instruction from the count buffer according to the information identifier, and delete the address-related information of the unconditional jump instruction stored in the count buffer. The instruction retiring circuitry can determine a jump target address (e.g., an address of a next instruction to be executed or retired) of the unconditional jump instruction according to address information of the unconditional jump instruction and the execution result indicating that a jump is determined. The instruction retiring circuitry can update the retirement counter with the jump target address as address information of the next instruction to be retired.

It is appreciated that instruction processing apparatuses according to the present disclosure may be implemented as a processor core, and the instruction processing method may be executed in the processor core. The processor core may be implemented in different processors in different manners. For example, the processor core may be implemented as a general ordered core for general computing, a high-performance general unordered core for general computing, and a dedicated core for graphics or scientific (throughput) computing. The processor may be implemented as a Central Processing Unit (“CPU”) or co-processor, where the CPU may include one or more general ordered cores or one or more general unordered cores, and the co-processor may include one or more dedicated cores. Such a combination of different processors may lead to different computer system architectures. For example, in some embodiments, the co-processor can be located on a chip separate from the CPU. In some embodiments, the co-processor can be located in the same package as the CPU but on a separate die. In some embodiments, the co-processor can be located on the same die as the CPU. The co-processor can sometimes be referred to as dedicated logic such as integrated graphics or scientific (throughput) logic, or referred to as a dedicated core. In some embodiments, the system is a system on chip, and the described CPU (e.g., an application core or application processor), the co-processor described above, and additional functions may be included on the same die.

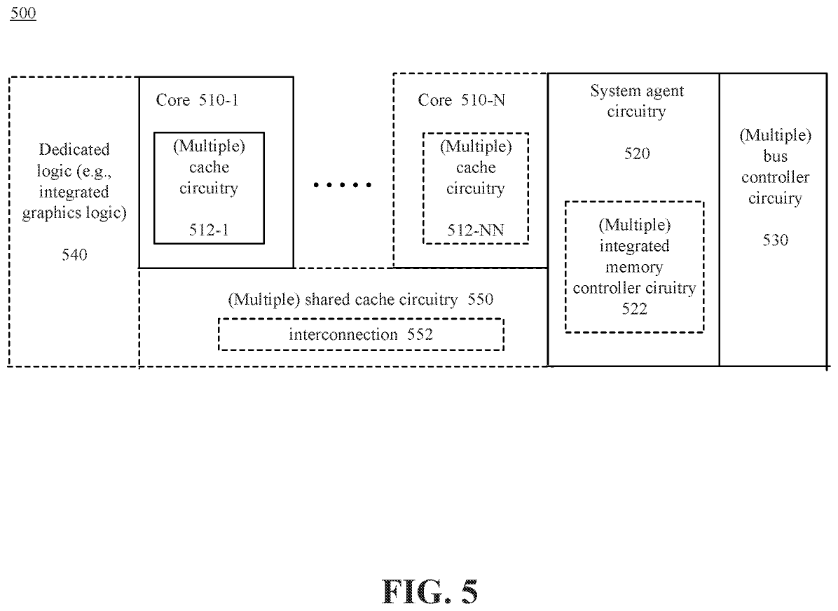

FIG. 5 is a schematic of an example processor, according to some embodiments of the present disclosure. In some embodiments, as shown by the solid line boxes in FIG. 5, processor 500 can include single core 510-1, system agent circuitry 520, and bus controller circuitry 530. In some embodiments, as shown by the dotted boxes in FIG. 5, processor 500 may further include a plurality of cores 510-1 to 510-N, integrated memory controller circuitry 522 in system agent circuitry 520, or dedicated logic 540.

In some embodiments, processor 500 may be implemented as a CPU. Dedicated logic 540 can be the integrated graphics or scientific (throughput) logic, which may include one or more cores. Cores 510-1 to 510-N can be one or more general cores (e.g., a general ordered core, a general unordered core, or a combination of both). In some embodiments, processor 500 may be implemented as a co-processor, and cores 510-1 to 510-N can be a plurality of dedicated cores for graphics or scientific (throughput) operations. In some embodiments, processor 500 may be implemented as a co-processor, and cores 510-1 to 510-N can be a plurality of general ordered cores. For example, processor 500 may be a general processor, a co-processor, or a dedicated processor such as a network or communication processor, a compression engine, a graphics processor, a general-purpose graphics processing unit (“GPGPU”), a high-throughput many integrated core (“MIC”) co-processor (which may include 30 or more cores), or an embedded processor. The processor may be implemented on one or more chips. In some embodiments, processor 500 may be part of one or more substrates, or may be implemented on one or more substrates by using any of a plurality of processing techniques such as, BiCMOS, CMOS, or NMOS.

In some embodiments, a memory hierarchical structure can include one or more levels of cache within each core, one or more shared cache circuitries 550, or an external memory (not shown) communicatively coupled to integrated memory controller circuitry 522. Shared cache circuitry 550 may include one or more intermediate level caches, such as level 2 (“L2”), level 3 (“L3”), level 4 (“L4”) or other levels of cache, last level cache (“LLC”), or combinations thereof. In some embodiments, interconnection circuitry 552 can interconnect integrated graphics logic 540, shared cache circuitry 550, and system agent circuitry 520/integrated memory controller circuitry 522. In some embodiments, interconnection circuitry 552 is a ring-based interconnection.

In some embodiments, system agent circuitry 520 includes components that coordinate and operate cores 510-1 to 510-N. For example, system agent circuitry 520 may include a power control unit (“PCU”) including circuitries or a display circuitry. The PCU may include logic and components needed to adjust power states of cores 510-1 to 510-N or integrated graphics logic 540. The display circuitry can drive one or more externally connected displays.

In some embodiments, cores 510-1 to 510-N may have the core architecture described above with reference to FIG. 1 and may be homogeneous or heterogeneous in terms of architectural instruction set. For example, two or more of the cores 510-1 to 510-N may be able to execute the same instruction set, while other cores may be able to execute only a subset of the instruction set or a different instruction set.

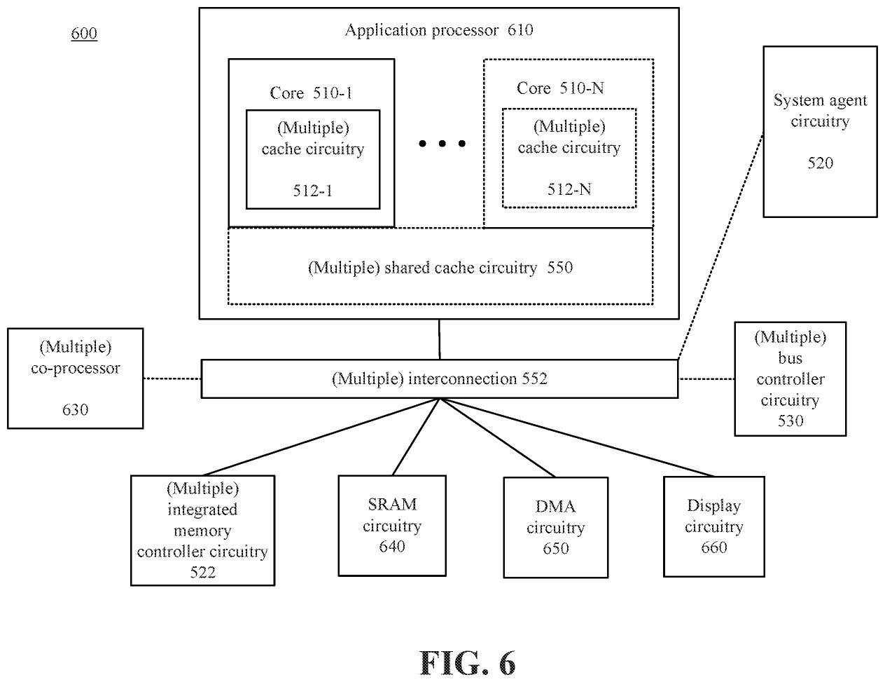

FIG. 6 is a schematic of an example system on chip, according to some embodiments of the present disclosure. In some embodiments, system on chip 600 shown in FIG. 6 can include includes processor 500 shown in FIG. 5, and therefore the components similar to those in FIG. 5 can have the same reference numerals. As shown in FIG. 6, interconnection 552 can be communicatively coupled to application processor 610, system agent circuitry 520, bus controller circuitry 530, integrated memory controller circuitry 522, one or more co-processors 630, static random access memory (“SRAM”) circuitry 640, direct memory access (“DMA”) circuitry 650, and display circuitry 660 communicatively coupled to one or more external displays. In some embodiments, application processor 610 can include a set of one or more cores 510-1 to 510-N and shared cache circuitry 550. In some embodiments, co-processor 630 can include integrated graphics logic, an image processor, an audio processor, and a video processor. In some embodiments, co-processor 630 can include a dedicated processor, such as a network or communication processor, a compression engine, a GPGPU, a high-throughput MIC processor, or an embedded processor.

In some embodiments, system on chip 600 may be included in an intelligent device in order to realize corresponding functions in the intelligent device. For example, the functions can include executing related control programs, performing data analysis, operation and processing, network communication, and controlling peripheral devices in the intelligent device.

In some embodiments, the intelligent devices can be specialized intelligent devices, such as mobile terminals or personal digital terminals. These devices can include one or more systems on chip (e.g., system on chip 600 of FIG. 6) according to the present disclosure to perform data processing or control peripheral devices in the device.

In some embodiments, the intelligent devices can be dedicated devices constructed to achieve specific functions, such as intelligent speakers or intelligent display devices. These devices include the system on chip (e.g., system on chip 600 of FIG. 6) according to the present disclosure to control the speaker and the display device, thereby giving the speaker and the display device additional functions such as communication, perception, and data processing.

In some embodiments, the intelligent devices can be various internet of things (“IoT”) and artificial intelligence of things (“AIoT”) devices. These devices can include the system on chip (e.g., system on chip 600 of FIG. 6) according to the present disclosure for data processing (e.g., performing AI operations, data communication and transmission, etc.), thereby achieving a denser and more intelligent device distribution.

In some embodiments, the intelligent devices can also be used in vehicles. For example, the intelligent devices may be implemented as in-vehicle devices or may be embedded in vehicles to provide data processing capabilities for intelligent driving of the vehicles.

In some embodiments, the intelligent devices may be used in home and entertainment fields. For example, the intelligent devices may be implemented as intelligent speakers, intelligent air conditioners, intelligent refrigerators, intelligent display devices, etc. These devices can include the system on chip according to the present disclosure for data processing and peripheral control, thereby realizing intelligentization of home and entertainment devices.

In some embodiments, the intelligent devices can be used in industrial fields For example, the intelligent devices may be implemented as industrial control devices, sensing devices, IoT devices, AIoT devices, or braking devices. These devices can include the system on chip (e.g., system on chip 600 of FIG. 6) according to the present invention for data processing and peripheral control, thereby realizing intelligentization of industrial equipment.

It is appreciated that the intelligent device according to the present disclosure is not limited to the descriptions above, and all intelligent devices that can perform data processing using the system on chip according to the present disclosure are within the protection scope of the present disclosure.

In various example embodiments described herein are described in the general context of method steps or processes, which may be implemented in one aspect by a computer program product, embodied in a computer-readable medium, including computer-executable instructions, such as program code, executed by computers to program the processors. A computer-readable medium may include removeable and nonremovable storage devices including, but not limited to, Read Only Memory, Random Access Memory, compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

The embodiments may further be described using the following clauses:

1. An instruction processing apparatus, comprising:

a count buffer;

an instruction fetching circuitry configured to store address-related information of a jump instruction into the count buffer and to determine an information identifier corresponding to the address-related information, wherein the address-related information comprises address information of the jump instruction in a storage device; and

an instruction executing circuitry configured to acquire the address-related information of the jump instruction from the count buffer according to the information identifier and execute the jump instruction according to the address-related information.

2. The apparatus of clause 1, further comprising:

an instruction retiring circuitry communicatively coupled to the instruction executing circuitry and the count buffer and configured to receive the information identifier from the instruction executing circuitry and to acquire the address-related information of the jump instruction from the count buffer according to the information identifier to retire the jump instruction.

3. The apparatus of clause 1 or 2, wherein the instruction fetching circuitry is further configured to:

pre-decode an instruction to determine an opcode of the instruction; and

determine, according to the opcode, whether the instruction is a jump instruction.

4. The apparatus of any one of clauses 1 to 3, wherein the instruction fetching circuitry is further configured to determine if the jump instruction is a conditional jump instruction or an unconditional jump instruction.

5. The apparatus of clause 4, wherein the instruction fetching circuitry is further configured to:

in response to a determination that the jump instruction is a conditional jump instruction, predict whether the conditional jump instruction leads to a jump, and store into the count buffer a prediction result and address information of the conditional jump instruction as address-related information of the conditional jump instruction.

6. The apparatus of clause 5, wherein the instruction fetching circuitry is further configured to:

determine, according to the prediction result, address information of a next instruction to be read.

7. The apparatus of clause 5 or 6, wherein the instruction executing circuitry is further configured to:

execute the conditional jump instruction to obtain an execution result indicating whether a jump occurs;

acquire the prediction result of the conditional jump instruction from the count buffer according to the information identifier;

determine whether the prediction result is consistent with the execution result of the conditional jump instruction; and

send a determination result and the information identifier to an instruction retiring circuitry to make the instruction retiring circuitry to determine, according to the determination result and the information identifier, address information of a next instruction to be retired.

8. The apparatus of clause 7, wherein the instruction retiring circuitry is configured to:

receive the determination result and the information identifier sent from the instruction executing circuitry;

acquire the address-related information of the conditional jump instruction from the count buffer according to the information identifier;

delete the address-related information of the conditional jump instruction from the count buffer; and

determine, according to the determination result, the address information and the prediction result of the conditional jump instruction, the address information of a next instruction to be retired.

9. The apparatus of clause 8, wherein the instruction retiring circuitry is further configured to:

in response to the determination result indicating that the prediction result is inconsistent with the execution result, determine, according to the determination result and the address information of the conditional jump instruction, address information of a next instruction to be read.

10. The apparatus of clause 4, wherein the instruction fetching circuitry is further configured to:

in response to a determination that the jump instruction is an unconditional jump instruction, determine a jump target address of the unconditional jump instruction, and indicate the jump target address as address information of a next instruction to be read.

11. The apparatus of clause 10, wherein the instruction executing circuitry is further configured to:

execute the unconditional jump instruction to obtain an execution result indicating that a jump is determined.

12. The apparatus of clause 11, further comprising an instruction retiring circuitry configured to:

receive the execution result of the unconditional jump instruction and the information identifier sent from the instruction executing circuitry;

acquire address-related information of the unconditional jump instruction from the count buffer according to the information identifier;

delete the address-related information of the unconditional jump instruction from the count buffer;

determine a jump target address of the unconditional jump instruction according to address information and the execution result of the unconditional jump instruction; and

indicate the jump target address as address information of a next instruction to be retired.

13. The apparatus of any one of clauses 1-12, wherein the information identifier is determined according to a storage position of the address-related information of the jump instruction in the count buffer.

14. The apparatus of any one of clauses 1-13, wherein the count buffer includes a queue data structure.

15. An instruction processing method, comprising:

storing, by an instruction fetching circuitry, address-related information of a jump instruction into a count buffer;

determining an information identifier corresponding to the address-related information, wherein the address-related information comprises address information of the jump instruction in a storage device;

acquiring, by an instruction executing circuitry, the address-related information of the jump instruction from the count buffer according to the information identifier; and

executing, by the instruction executing circuitry, the jump instruction according to the address-related information.

16. The method of clause 15, further comprising:

receiving, by an instruction retiring circuitry, the information identifier sent from the instruction executing circuitry; and

acquiring, by the instruction retiring circuitry, the address-related information of the jump instruction from the count buffer according to the information identifier to retire the jump instruction.

17. The method of clause 15 or 16, further comprising:

pre-decoding a read instruction to determine an opcode of the instruction; and

determining, according to the opcode, whether the instruction is a jump instruction.

18. The method of any one of clauses 15 to 17, further comprising:

determining whether the jump instruction is a conditional jump instruction or an unconditional jump instruction.

19. The method of clause 18, further comprising:

in response to a determination that the jump instruction is a conditional jump instruction, predicting whether the conditional jump instruction leads to a jump; and

storing into the count buffer a prediction result and address information of the conditional jump instruction as address-related information of the conditional jump instruction.

20. The method of clause 19, further comprising:

determining, according to the prediction result, address information of a next instruction to be read.

21. The method of clause 19 or 20, wherein executing, by the instruction executing circuitry, the jump instruction according to the address-related information comprises:

executing the conditional jump instruction to obtain an execution result indicating whether a jump occurs;

acquiring the prediction result of the conditional jump instruction from the count buffer according to the information identifier;

determining whether the prediction result is consistent with the execution result of the conditional jump instruction; and

determining, according to a determination result and the information identifier, address information of a next instruction to be retired.

22. The method of clause 21, wherein determining, according to a determination result and the information identifier, address information of a next instruction to be retired comprises:

acquiring the address-related information of the conditional jump instruction from the count buffer according to the information identifier;

deleting the address-related information of the conditional jump instruction from the count buffer; and

determining, according to the determination result, the address information and the prediction result of the conditional jump instruction, the address information of a next instruction to be retired.

23. The method of clause 22, further comprising:

in response to the determination result indicating that the prediction result is inconsistent with the execution result, determining, according to the determination result and the address information of the conditional jump instruction, address information of a next instruction to be read.

24. The method of clause 18, further comprising:

in response to a determination that the jump instruction is an unconditional jump instruction, determining a jump target address of the unconditional jump instruction, and indicating the jump target address as address information of a next instruction to be read.

25. The method of clause 24, wherein executing, by the instruction executing circuitry, the jump instruction according to the address-related information comprises:

executing the unconditional jump instruction to obtain an execution result indicating that a jump is determined; and

determining, according to an execution result and the information identifier, address information of a next instruction to be retired.

26. The method of clause 25, wherein determining, according to an execution result and the information identifier, address information of a next instruction to be retired comprises:

acquiring address-related information of the unconditional jump instruction from the count buffer according to the information identifier;

deleting the address-related information of the unconditional jump instruction from the count buffer;

determining a jump target address of the unconditional jump instruction according to address information and the execution result of the unconditional jump instruction; and

indicating the jump target address as address information of a next instruction to be retired.

27. The method of any one of clauses 18-26, wherein the information identifier is determined according to a storage position of the address-related information of the jump instruction in the count buffer.

28. A system on chip, comprising:

an instruction processing apparatus, comprising:
a count buffer;
an instruction fetching circuitry configured to store address-related information of a jump instruction into the count buffer and to determine an information identifier corresponding to the address-related information, wherein the address-related information comprises address information of the jump instruction in a storage device; and
an instruction executing circuitry configured to acquire the address-related information of the jump instruction from the count buffer according to the information identifier and execute the jump instruction according to the address-related information.

29. An intelligent device, comprising:

a system on chip, comprising:
an instruction processing apparatus, comprising:
   a count buffer;
   an instruction fetching circuitry configured to store address-related information of a jump instruction into the count buffer and to determine an information identifier corresponding to the address-related information, wherein the address-related information comprises address information of the jump instruction in a storage device; and
   an instruction executing circuitry configured to acquire the address-related information of the jump instruction from the count buffer according to the information identifier and execute the jump instruction according to the address-related information.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the embodiments disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

Those skilled in the art should understand that the modules, circuitries, units or components of the device in the examples disclosed herein may be arranged in the device as described in the embodiments, or alternatively may be positioned in one or more devices different from the device. The modules, circuitries, units or components, may be combined into one module or, in addition, may be divided into a plurality of sub-modules.

In addition, those skilled in the art can understand that although some of the embodiments described herein include certain features included in other embodiments but not other features, the combination of features of different embodiments is meant to be within the scope of the present disclosure and form different embodiments.

As used herein, unless otherwise specified, the use of ordinal words “first,” “second,” “third,” etc. to describe ordinary objects merely indicates different instances involving similar objects and is not intended to imply the objects described as such must have a given order in time, space, order, or in any other way.

In the drawings and specification, there have been disclosed exemplary embodiments. Many variations and modifications, however, can be made to these embodiments. Accordingly, although specific terms are employed, they are used in a generic and descriptive sense only and not for purposes of limitation, the scope of the embodiments being defined by the following claims.

What is claimed is:

1. An instruction processing apparatus, comprising:
a count buffer;
an instruction fetching circuitry configured to store address-related information of a jump instruction into the count buffer and to determine an information identifier corresponding to the address-related information, wherein the address-related information comprises address information of the jump instruction in a storage device; and
an instruction executing circuitry configured to acquire the address-related information of the jump instruction from the count buffer according to the information identifier and execute the jump instruction according to the address-related information.

2. The apparatus of claim 1, further comprising:
an instruction retiring circuitry communicatively coupled to the instruction executing circuitry and the count buffer and configured to receive the information identifier from the instruction executing circuitry and to acquire the address-related information of the jump instruction from the count buffer according to the information identifier to retire the jump instruction.

3. The apparatus of claim 1, wherein the instruction fetching circuitry is further configured to:
pre-decode an instruction to determine an opcode of the instruction; and
determine, according to the opcode, whether the instruction is a jump instruction.

4. The apparatus of claim 1, wherein the instruction fetching circuitry is further configured to determine if the jump instruction is a conditional jump instruction or an unconditional jump instruction.

5. The apparatus of claim 4, wherein the instruction fetching circuitry is further configured to:
in response to a determination that the jump instruction is a conditional jump instruction, predict whether the conditional jump instruction leads to a jump, and store into the count buffer a prediction result and address information of the conditional jump instruction as address-related information of the conditional jump instruction.

6. The apparatus of claim 5, wherein the instruction fetching circuitry is further configured to:
determine, according to the prediction result, address information of a next instruction to be read.

7. The apparatus of claim 5, wherein the instruction executing circuitry is further configured to:
execute the conditional jump instruction to obtain an execution result indicating whether a jump occurs;
acquire the prediction result of the conditional jump instruction from the count buffer according to the information identifier;
determine whether the prediction result is consistent with the execution result of the conditional jump instruction; and
send a determination result and the information identifier to an instruction retiring circuitry to make the instruction retiring circuitry to determine, according to the determination result and the information identifier, address information of a next instruction to be retired.

8. The apparatus of claim 7, wherein the instruction retiring circuitry is configured to:
receive the determination result and the information identifier sent from the instruction executing circuitry;
acquire the address-related information of the conditional jump instruction from the count buffer according to the information identifier;
delete the address-related information of the conditional jump instruction from the count buffer; and
determine, according to the determination result, the address information and the prediction result of the conditional jump instruction, the address information of a next instruction to be retired.

9. The apparatus of claim 8, wherein the instruction retiring circuitry is further configured to:
in response to the determination result indicating that the prediction result is inconsistent with the execution result, determine, according to the determination result and the address information of the conditional jump instruction, address information of a next instruction to be read.

10. The apparatus of claim 4, wherein the instruction fetching circuitry is further configured to:
in response to a determination that the jump instruction is an unconditional jump instruction, determine a jump target address of the unconditional jump instruction, and indicate the jump target address as address information of a next instruction to be read.

11. The apparatus of claim 10, wherein the instruction executing circuitry is further configured to:
execute the unconditional jump instruction to obtain an execution result indicating that a jump is determined.

12. The apparatus of claim 11, further comprising an instruction retiring circuitry configured to:
receive the execution result of the unconditional jump instruction and the information identifier sent from the instruction executing circuitry;
acquire address-related information of the unconditional jump instruction from the count buffer according to the information identifier;
delete the address-related information of the unconditional jump instruction from the count buffer;
determine a jump target address of the unconditional jump instruction according to address information and the execution result of the unconditional jump instruction; and
indicate the jump target address as address information of a next instruction to be retired.

13. The apparatus of claim 1, wherein the information identifier is determined according to a storage position of the address-related information of the jump instruction in the count buffer.

14. The apparatus of claim 1, wherein the count buffer includes a queue data structure.

15. An instruction processing method, comprising:
storing, by an instruction fetching circuitry, address-related information of a jump instruction into a count buffer;
determining an information identifier corresponding to the address-related information, wherein the address-related information comprises address information of the jump instruction in a storage device;
acquiring, by an instruction executing circuitry, the address-related information of the jump instruction from the count buffer according to the information identifier; and
executing, by the instruction executing circuitry, the jump instruction according to the address-related information.

16. The method of claim 15, further comprising:
receiving, by an instruction retiring circuitry, the information identifier sent from the instruction executing circuitry; and
acquiring, by the instruction retiring circuitry, the address-related information of the jump instruction from the count buffer according to the information identifier to retire the jump instruction.

17. The method of claim 15, further comprising:
pre-decoding a read instruction to determine an opcode of the instruction; and
determining, according to the opcode, whether the instruction is a jump instruction.

18. The method of claim 15, further comprising:
determining whether the jump instruction is a conditional jump instruction or an unconditional jump instruction.

19. The method of claim 18, further comprising:
in response to a determination that the jump instruction is a conditional jump instruction, predicting whether the conditional jump instruction leads to a jump; and
storing into the count buffer a prediction result and address information of the conditional jump instruction as address-related information of the conditional jump instruction.

20. The method of claim 19, further comprising:
determining, according to the prediction result, address information of a next instruction to be read.

21. The method of claim 19, wherein executing, by the instruction executing circuitry, the jump instruction according to the address-related information comprises:
executing the conditional jump instruction to obtain an execution result indicating whether a jump occurs;
acquiring the prediction result of the conditional jump instruction from the count buffer according to the information identifier;
determining whether the prediction result is consistent with the execution result of the conditional jump instruction; and
determining, according to a determination result and the information identifier, address information of a next instruction to be retired.

22. The method of claim 21, wherein determining, according to a determination result and the information identifier, address information of a next instruction to be retired comprises:
acquiring the address-related information of the conditional jump instruction from the count buffer according to the information identifier;
deleting the address-related information of the conditional jump instruction from the count buffer; and
determining, according to the determination result, the address information and the prediction result of the conditional jump instruction, the address information of a next instruction to be retired.

23. The method of claim 22, further comprising:
in response to the determination result indicating that the prediction result is inconsistent with the execution result, determining, according to the determination result and the address information of the conditional jump instruction, address information of a next instruction to be read.

24. The method of claim 18, further comprising:
in response to a determination that the jump instruction is an unconditional jump instruction, determining a jump target address of the unconditional jump instruction, and indicating the jump target address as address information of a next instruction to be read.

25. The method of claim 24, wherein executing, by the instruction executing circuitry, the jump instruction according to the address-related information comprises:
executing the unconditional jump instruction to obtain an execution result indicating that a jump is determined; and
determining, according to an execution result and the information identifier, address information of a next instruction to be retired.

26. The method of claim 25, wherein determining, according to an execution result and the information identifier, address information of a next instruction to be retired comprises:
acquiring address-related information of the unconditional jump instruction from the count buffer according to the information identifier;
deleting the address-related information of the unconditional jump instruction from the count buffer;
determining a jump target address of the unconditional jump instruction according to address information and the execution result of the unconditional jump instruction; and
indicating the jump target address as address information of a next instruction to be retired.

27. The method of claim 18, wherein the information identifier is determined according to a storage position of the address-related information of the jump instruction in the count buffer.

28. A system on chip, comprising:
an instruction processing apparatus, comprising:
a count buffer;
an instruction fetching circuitry configured to store address-related information of a jump instruction into the count buffer and to determine an information identifier corresponding to the address-related information, wherein the address-related information comprises address information of the jump instruction in a storage device; and
an instruction executing circuitry configured to acquire the address-related information of the jump instruction from the count buffer according to the information identifier and execute the jump instruction according to the address-related information.

29. An intelligent device, comprising:
a system on chip, comprising:
an instruction processing apparatus, comprising:
a count buffer;
an instruction fetching circuitry configured to store address-related information of a jump instruction into the count buffer and to determine an information identifier corresponding to the address-related information, wherein the address-related information comprises address information of the jump instruction in a storage device; and
an instruction executing circuitry configured to acquire the address-related information of the jump instruction from the count buffer according to the information identifier and execute the jump instruction according to the address-related information.
